(19) United States
(12) Patent Application Publication
(10) Pub. No.: US 2023/0089955 A1
(43) Pub. Date: Mar. 23, 2023

(54) PIN ASSIGNMENTS BASED ON VOLTAGE RANGES

(71) Applicant: Hewlett-Packard Development Company, L.P., Spring, TX (US)

(72) Inventors: Fangyong Dai, Spring, TX (US); Richard Shi Jian Lin, Spring, TX (US); Xiang Ma, Spring, TX (US); Baosheng Zhang, Spring, TX (US)

(73) Assignee: Hewlett-Packard Development Company, L.P., Spring, TX (US)

(21) Appl. No.: 17/908,928

(22) PCT Filed: Apr. 7, 2020
(86) PCT No.: PCT/US2020/027017

§ 371 Date: Sep. 2, 2022

(51) Int. Cl. G06F 1/18

(52) U.S. Cl. CPC G06F 1/189; G06F 1/185

(57) ABSTRACT

In one example in accordance with the present disclosure, a computing device is described. An example computing device includes an integrated circuit chip having a first pin and a second pin. The example computing device also includes a conversion circuit. An example conversion circuit assigns an output of the first pin to a first voltage range and assigns the output of the first pin to a voltage value within the first voltage range based on a logical value of the output of the first pin. The example conversion circuit also assigns an output of the second pin to a second voltage range that is different from the first voltage range and assigns the output of the second pin to a voltage value within the second voltage range based on a logical value of the output of the second pin.

### BACKGROUND

Computing devices carry out any number of operations and include various hardware components that communicate with one another. For example, a computing device may include a motherboard or other similar circuit board that is connected to numerous other circuit boards of a computing device and which coordinates their operations. These other printed circuit boards extend the functionality of the computing device. Examples of other printed circuit boards include expansion cards that add new functionality to a device and daughterboards that support the operations of the motherboard.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a computing device for assigning pin outputs to voltage ranges, according to an example.

FIG. 2 is a circuit diagram of a conversion circuit for assigning pin outputs to voltage ranges, according to an example.

FIG. 3 is a circuit diagram of a conversion circuit for assigning pin outputs to voltage ranges, according to an example.

FIG. 4 is a block diagram of a computing device for decoding signals based on voltage ranges, according to an example.

FIG. 5 is a circuit diagram of a decoding circuit for decoding signals based on voltage ranges, according to an example.

FIG. 6 is a diagram of two printed circuit boards for assigning and decoding pin signals based on voltage ranges, according to an example.

FIG. 7 is a flowchart of a method for assigning and decoding pin signals based on voltage ranges, according to an example.

FIG. 8 is a circuit diagram of a conversion circuit for assigning pin outputs to voltage ranges, according to an example.

FIG. 9 is a flowchart of a method for assigning and decoding pin signals based on voltage ranges, according to another example.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

As described above, a computing device includes a wide variety of circuit boards that carry out different functions. Circuit boards include integrated circuit chips that carry out different operations. For example, one integrated circuit chip may manage a display device, another an audio device, and yet another may provide storage for the computing device. These different integrated circuit chips may be connected to one another via cables. As a specific example, a computing device may include a motherboard, which acts as a central controller for other components of the computing device. The motherboard may provide power to these other integrated circuits.

As computing devices have become a ubiquitous part of society and trends indicate that societal demand for and reliance on computing devices is likely to increase at an even greater rate, developments to enhance their operation may result in greater functionality for computing devices.

Specifically, there is a demand to increase computing device functionality. Additionally, there is demand for computing devices that are smaller and more portable. Accordingly, the space within the physical housing of a computing device is at a premium. In some cases, size limitations within computing devices may be a limiting factor in the development of computing capability.

The present specification describes devices and methods for making space available within a computing device and for more effectively transmitting data between components of the computing device.

Accordingly, the present specification describes an analog voltage-based approach to combine multiple signals into one wire between two integrated circuit chips, while still maintaining the same signal count between the two integrated circuit chips as compared to the signals that would have been transmitted via a multi-wire cable. In some examples, the integrated circuits may be on different computing devices or the same computing device. That is, where previously one wire is dedicated to one signal between two integrated circuit chips connected by the cable, the present specification describes the use of analog voltage ranges to combine multiple signals into one wire for connecting the two integrated circuit chips.

As used in the present specification and in the appended claims, the term “a number of” or similar language is meant to be understood broadly as any positive number including 1 to infinity.

Further, as used in the present specification and in the appended claims, the term “cable” refers to a multi-wire communication path between two integrated circuit chips. By comparison, a “wire” refers to a single electrical connection between two integrated circuit chips.

In the application, use of the designator “−1” references a specific instance of a component while the absence of the designator references the component in general. For example, the reference number (104) refers generally to all pins, while the reference number (104-1) indicates a particular instance, i.e., a first instance, of the pin.

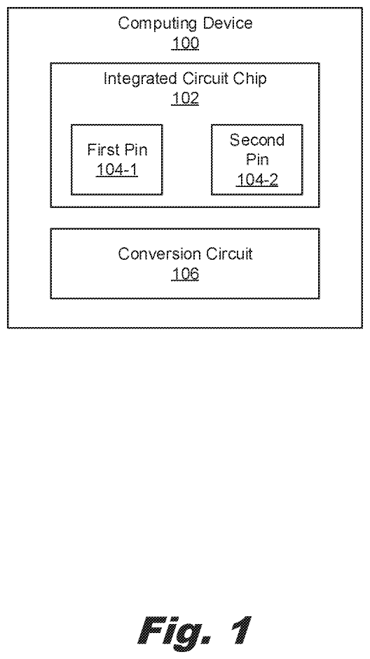

Turning now to the figures, FIG. 1 is a block diagram of a computing device (100) for assigning pin (104) outputs to voltage ranges. The computing device (100) may be of a variety of types. For example, the computing device (100) may be a desktop computer, a laptop, a gaming system, a tablet, a server or any other computing device (100) that includes integrated circuit chips that communicate with one another via cables.

The computing device (100) includes an integrated circuit chip (102). As described above, there are a variety of integrated circuit chips (102) within a computing device (100). For example, the integrated circuit chip (102) may be found on a motherboard that controls, directs, and manages the operation of a variety of other integrated circuit chips on other printed circuit boards such as a daughterboard or an expansion board.

The integrated circuit chip (102) has at least a first pin (104-1) and a second pin (104-2). The pins (104) are physical components that make electrical connections with a circuit board on which the integrated circuit chip (102) is disposed. For example, through these pins (104) signals may be routed to or from the integrated circuit chip (102). Electrical signals are passed along the different pins (104) with different pins related to different functions. In a particular example, of a 9-pin integrated circuit chip (102) for communicating between a motherboard and an input/output daughterboard, the pins (104) may include, from a motherboard to a daughter board, 1) a universal serial bus (USB) power enable pin, 2) a power light-emitting diode (LED) pin, 3) a Mute LED pin, 4) a USB power limit pin, and 5) a system reset pin, and from a daughter board to the motherboard, 6) a power button pin, 7) a mute button pin, 8) an audio volume up pin and 9) an audio volume down pin.

As described above, rather than communicating the signal for a pin (104) on a dedicated wire, the transmit pins (102), that is the pins sending signals from a first integrated circuit chip (102) to a second integrated circuit chip (102), may be multiplexed together.

Similarly, the receive pins (104), that is the pins (104) receiving signals at the first integrated circuit chip (102) from the second integrated circuit chip (102), may be multiplexed together. That is, in the above example of a 9-pin integrated circuit chip (102), the last four pins (104) may be receive pins and are therefore multiplexed into a single wire.

To allow such multiplexing, the computing device includes a conversion circuit (106). In general, the conversion circuit (106) assigns the output of the first pin (102-1) to a first voltage range which is unique to that first pin (104-1). Note that during general operation, the first pin (104-1), and others, may output a variety of logical values. For example, the first pin (104-1) may output a logical 1 value or a logical 0 value. To distinguish between the logical values, the conversion circuit (106) assigns the output of the first pin (102-1) to a voltage value within the first voltage range based on a logical value of the output of the first pin (104-1).

For example, the conversion circuit (106) may assign an output of the first pin (104-1) to a voltage range of 0-0.9 volts (V). The conversion circuit (106) may assign a first logical value such as logic 0, to a 0 V value and may assign a second logic value such as logic 1, to a 0.9 V value. As can be seen from this example, logical values are uniquely assigned particular voltage values within the first voltage range that is unique to the first pin (104-1).

Similarly, the conversion circuit (106) assigns the output of the second pin (104-2) to a second voltage range which is unique to that second pin (104-2). To distinguish between the logical values, the conversion circuit (106) assigns the output of the second pin (104-2) to a voltage value within the second voltage range based on a logical value of the output of the second pin (104-2).

For example, the conversion circuit (106) may assign an output of the second pin (104-2) to a voltage range of 1-1.9 V. The conversion circuit (106) may assign a first logical value, such as logic 0, to a 1 V value and may assign a second logical value, such as logic 1, to a 1.9 V value. As can be seen from this example, logical values are uniquely assigned particular voltage values within the second voltage range that is unique to the second pin (104-2).

Using a 9-signal communication path as described above, a complete mapping of pins (104) to voltage ranges is now provided. For a first direction, i.e., from a motherboard to a daughterboard, which multiplexes five signals, the conversion circuit (106) may assign an output of a first pin (104-1) to a voltage range of 0-0.9 V, with a first logical value being assigned a voltage value of 0 V and a second logical value being assigned a voltage value of 0.9 V.

Similarly, the conversion circuit (106) may assign an output of a second pin (104-2) to a voltage range of 1-1.9 V, with a first logical value being assigned a voltage value of 1 V and a second logical value being assigned a voltage value of 1.9 V.

Still further, the conversion circuit (106) may assign an output of a third pin (104) to a voltage range of 2-2.9 V, with a first logical value being assigned a voltage value of 2 V and a second logical value being assigned a voltage value of 2.9 V.

Still further, the conversion circuit (106) may assign an output of a fourth pin (104) to a voltage range of 3-3.9 V, with a first logical value being assigned a voltage value of 3 V and a second logical value being assigned a voltage value of 3.9 V.

Still further, the conversion circuit (106) may assign an output of a fifth pin (104) to a voltage range of 4-4.9 V, with a first logical value being assigned a voltage value of 4 V and a second logical value being assigned a voltage value of 4.9 V.

Note that in an opposite direction, i.e., receive direction, as signals are transmitted along different wires, the voltage ranges may be re-used. That is, for a second direction, i.e., from a daughterboard to a motherboard, which multiplexes four signals, the conversion circuit (106) may assign an output of a sixth pin (104) to a voltage range of 0-0.9 V, with a first logical value being assigned a voltage value of 0 V and a second logical value being assigned a voltage value of 0.9 V.

Similarly, the conversion circuit (106) may assign an output of a seventh pin (104) to a voltage range of 1-1.9 V, with a first logical value being assigned a voltage value of 1 V and a second logical value being assigned a voltage value of 1.9 V.

Still further, the conversion circuit (106) may assign an output of an eighth pin (104) to a voltage range of 2-2.9 V, with a first logical value being assigned a voltage value of 2 V and a second logical value being assigned a voltage value of 2.9 V.

Still further, the conversion circuit (106) may assign an output of a ninth pin (104) to a voltage range of 3-3.9 V, with a first logical value being assigned a voltage value of 3 V and a second logical value being assigned a voltage value of 3.9 V. Table (1) below provides a summary of the mappings described above.

TABLE (1)

| Pin | Voltage Range |
|---|---|
| From the First Integrated Circuit Chip | |
| to the Second Integrated Circuit Chip | |
| 1 | 0-0.9 V |
| 2 | 1-1.9 V |
| 3 | 2-2.9 V |
| 4 | 3-3.9 V |
| 5 | 4-4.9 V |
| From the Second Integrated Circuit | |
| Chip to the First Integrated Circuit | |
| Chip | |
| 6 | 0-0.9 V |
| 7 | 1-1.9 V |
| 8 | 2-2.9 V |
| 9 | 3-3.9 V |

Note that Table 1 provides a particular example of pin-to-voltage mappings. However, other mappings may be implemented as well. For example, the pin outputs may be mapped to different voltage ranges.

A specific example of the operation of the conversion circuit (106) is now described. As described above, the output of a pin (104) may have different logical values which are represented as voltage values at the pin (104). For example, for logic 0, a voltage value of 0 V is at the pin (104). By comparison, for logic 1, a voltage value of 3 V is at the pin (104). This may be the same for each pin (104). That is, a pin (104) outputs either 0 V or 3 V to indicate a particular logical value. The conversion circuit (106) takes these values and offsets them differently per pin (104) such that the output voltage values indicating the logical value of the pin (104) are within a voltage range that is unique to that pin (104).

For example, when a voltage on a first pin (104-1) is 3 V, the conversion circuit (106) drives its output to 0.90 V. This is passed to an input of a second integrated circuit chip via the single wire. The second integrated circuit chip then detects this signal is within a voltage range assigned to a first pin (104-1) and has a voltage value indicative of logic 1. Accordingly, the second integrated circuit drives its signal 1 output to logic high, i.e., 3 V and delivers it to the corresponding pin on the second integrated circuit chip.

Using Pin 5 as another example, the conversion circuit (106) may detect a 0 V value. The conversion circuit (106) drives its output to 4.0 V to identify this signal as pertaining to Pin 5 with a logical value of 0. This gets passed through the single wire and reaches an input on a second integrated circuit chip. The second integrated circuit chip recognizes this value is within the Pin 5 voltage range and is logic low. Accordingly, the second integrated circuit chip drives its output on the second integrated circuit chip to 0.0 V and directs it to a corresponding pin (104) on the second integrated circuit chip.

In one particular example, the assigning and multiplexing may be for non-high-speed signals, for example those with less than a 100 kilohertz transmission rate. That is, some data protocols such as universal serial bus (USB) 2.0 and higher, serial advanced technology attachment (SATA), and peripheral component interconnect express (PCIe) may have high data rates and may not be suitable for this multiplexing, but other cables such as flat cables, or cables used to connect the integrated circuit chip (102) with a keyboard, an audio jack, detection cables, etc. may implement the conversion circuit (106) and associated multiplexing of data transmission signals.

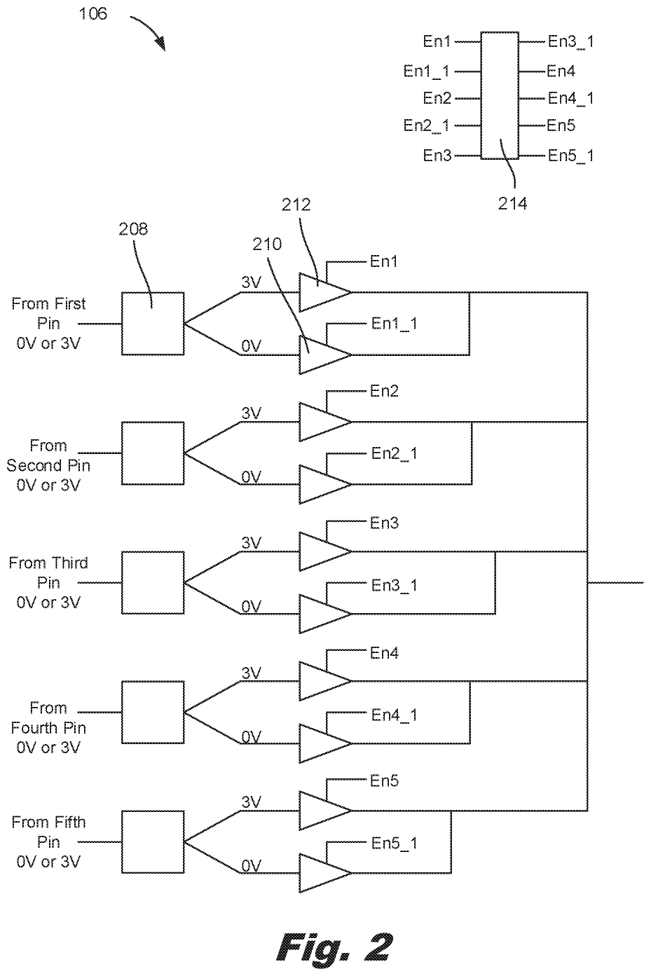

FIG. 2 is a circuit diagram of a conversion circuit (106) for assigning pin (FIG. 1, 104) outputs to voltage ranges. Specifically, FIG. 2 depicts a circuit diagram of the transmit pins (104), i.e., the first five pins (104) identified in Table (1). As described above, in this example, the output of a first pin (104-1) is assigned a voltage range of 0-0.9 V with a first logical value represented by 0 V and a second logical value represented by 0.9 V; the output of a second pin (104-2) is assigned a voltage range of 1-1.9 V with a first logical value represented by 1 V and a second logical value represented by 1.9 V; the output of a third pin (104) is assigned a voltage range of 2-2.9 V with a first logical value represented by 2 V and a second logical value represented by 2.9 V; the output of a fourth pin (104) is assigned a voltage range of 3-3.9 V with a first logical value represented by 3 V and a second logical value represented by 3.9 V; the output of a fifth pin (104) is assigned a voltage range of 4-4.9 V with a first logical value represented by 4 V and a second logical value represented by 4.9 V. As noted above these voltage range and value assignments are examples, and other may be implemented in accordance with the principles described herein.

As described above, the voltage at a pin (104), which may be a 0 V or a 3 V value, is assigned to a voltage range that is unique to that pin (FIG. 1, 104). To carry out this operation, the conversion circuit (106) may include, for the first pin (FIG. 1, 104-2) and other pins (FIG. 1, 104), a switch (208), a first logic converter (210) to assign the output of the first pin (FIG. 1, 104-2) to a first voltage value within the first voltage range when the output of the first pin (FIG. 1, 104-1) is a first logical value, and a second logic converter (212) to assign the output of the first pin (FIG. 1, 104-1) to a second voltage value within the first voltage range when the output of the first pin (FIG. 1, 104-1) is a second logical value. For simplicity, one instance of each of the switch (208), first logic converter (210), and second logic converter (212) have been indicated with reference numbers.

In operation, the switch (208) detects whether the voltage at the respective pin (FIG. 1, 104) is a high logical value, i.e. 3 V, or a low logical value, i.e., 0 V, and directs the signal to either the first logic converter (210) or the second logic converter (212). That is, depending on the voltage level, a switch (208) directs its output to a different logic converter (210, 212).

For example, if the Pin 1 voltage is 3 V, then the 3 V path is active and the signal is passed to the second logic converter (212). By comparison, if Pin 1 voltage is 0 V, then the 0 V path is active and the signal is passed to the first logic converter (210). Accordingly, the switch (208) may be a bi-directional switch such that when a first voltage value is received, one communication path is opened and when a second voltage value is received, another communication is active. In this example, the voltage value at the pin (FIG. 1, 104) is a trigger that opens/closes specific communication paths.

For example, the switch (208) may include a buffer that has an enable control pin. When the enable control pin of the switch (208) is 0 V, the buffer output is disabled and results in its output at high-Z state at 1.5 V. That 1.5 V level will disable both the 3 V path and 0 V path. By comparison, when the enable control pin is 3V, buffer output is enabled, and its output level is the same level as its input, either 0 V or 3 V. Accordingly, when the enable control pin is 3 V and the input from the pin is at 3 V, the 3 V path out of the switch (208) is enabled and the 0 V path out of the switch (208) is disabled. Similarly, when the enable control pin is at 3 V and the input from the pin is at 0 V, the 0 V path out of the switch (208) is enabled and the 3 V path is disabled. Accordingly, after the enable control pin is active, the input selects which paths (3 V or 0 V) is to be enabled, so that respective offsets are added.

The logic converters (210, 212) then offset the received voltage value to the appropriate voltage values within the appropriate voltage ranges. For example, relating to the logic converters (210, 212) associated with the first pin (FIG. 1, 104-1) and its switch (208), the first logic converter (210) adds 0 V offset on its output to generate a 0 V value to be output on the wire. The second logic converter (212), to place the input 3 V to its assigned voltage value, i.e., 0.9 V, the second logic converter (212) adds an offset of −2.1 V to the signal, thus changing the 3 V signal to a 0.9 V signal, which is within the voltage range assigned to the first pin (FIG. 1, 104-1). To accomplish this offset, the logic converters (210, 212) may include operational amplifiers that sum inputs. Accordingly, a first input to a logic converter may be the signal from the switch (208) and a second input may be a fixed offset voltage. Accordingly, the logic converters (210, 212), which may include operational amplifiers, sum and output the input value from the switch (208) plus a predetermined offset voltage.

As depicted in this example, the first logic converter (210) has a different offset value as compared to the second logic converter (212). That is, different logic converters have different offset values. Table 2 below provides an example of offsets for different logic converters (210, 212), with the logic converters (210, 212) being identified by the enable signal associated with it as indicated in FIG. 2.

TABLE 2

| Pin | Initial Voltage | Logic Converter | Offset Voltage | Output Voltage |
|---|---|---|---|---|
| 1 | 0 V (low logic) | En1 | 0 V | 0 V |
| 1 | 3 V (high logic) | En1_1 | −2.1 V | 0.9 V |
| 2 | 0 V (low logic) | En2 | +1 V | 1 V |
| 2 | 3 V (high logic) | En2_1 | −1.1 V | 1.9 V |
| 3 | 0 V (low logic) | En3 | +2 V | 2 V |
| 3 | 3 V (high logic) | En3_1 | −0.1 V | 2.9 |
| 4 | 0 V (low logic) | En4 | +3 V | 3 V |
| 4 | 3 V (high logic) | En4_1 | +0.9 V | 3.9 V |
| 5 | 0 V (low logic) | En5 | +4 V | 4 V |
| 5 | 3 V (high logic) | En5_1 | +1.9 V | 4.9 V |

Accordingly, as demonstrated in Table 2, a pin (FIG. 1, 104) may have a binary output, but those binary outputs are distinguished into unique voltage values via the operation of the switch (208), first logic converter (210), and second logic converter (212). Accordingly, different signals may be passed and uniquely identified along a single wire.

In some examples, the conversion circuit (106) includes a control circuit (214) to determine 1) which pin output is to be transmitted and 2) which of the first logic converter (210) and the second logic converter (212) is active. For example, the control circuit (214) individually selects logic converters associated with the first pin (FIG. 1, 104-1), logic converters associated with the second pin (FIG. 1, 104-2), logic converters associated with the third pin (FIG. 1, 104-1), logic converters associated with the fourth pin (FIG. 1, 104-4), or logic converters associated with the fifth pin (FIG. 1, 104). The control circuit (214) also enables one of the logic converters associated with a pin (FIG. 1, 104).

For example, in addition to determining that the first pin (FIG. 1, 104-2) logic converters (210, 212) are selected, the control circuit (214) also activates one of them via En1 or EN1_1, while keeping the other inactive. That is, while the first logic converter (210) is active via EN1, the second logic converter (212) is inactive. That is, the control circuit (214) may ensure that just one of ENx and ENx_1 is active at a time. For example, the control circuit (214) may include an inverter to make ENx_1 opposite of ENx, thus preventing both from being active at the same time.

In some examples, the selection of which pair of logic converters (210, 212) to enable may be as simple as rotating periodically. For example, at time t0, either EN1 or EN1_1 is active for 1 second, and the remaining enable signals are inactive. Doing so, activates the paths from the first pin (FIG. 1, 104-2), whether that be the path through the first logic converter (210) or the second logic converter (212). That is, if the first pin's (FIG. 1, 104-1) +3 V path is active, EN1 is true and EN1_1 is inactive. So, 0.9 V is output to the wire. By comparison, if the first pin's (FIG. 1, 104-1) 0 V path is active, EN1 is inactive while EN1_1 is active. So, 0 V is output to the wire.

At time t1, either EN2 or EN2_1 is active. Accordingly, during t1, the output on the wire is the second pin's (FIG. 1, 104-2) active path output. For example, if the second pin (FIG. 1, 104-2) is at 3.0 V, the output on the single transmission cable is 1.9 V. By comparison, if the second pin's (FIG. 1, 104-2) active path is 0 V, the output is 1.0 V.

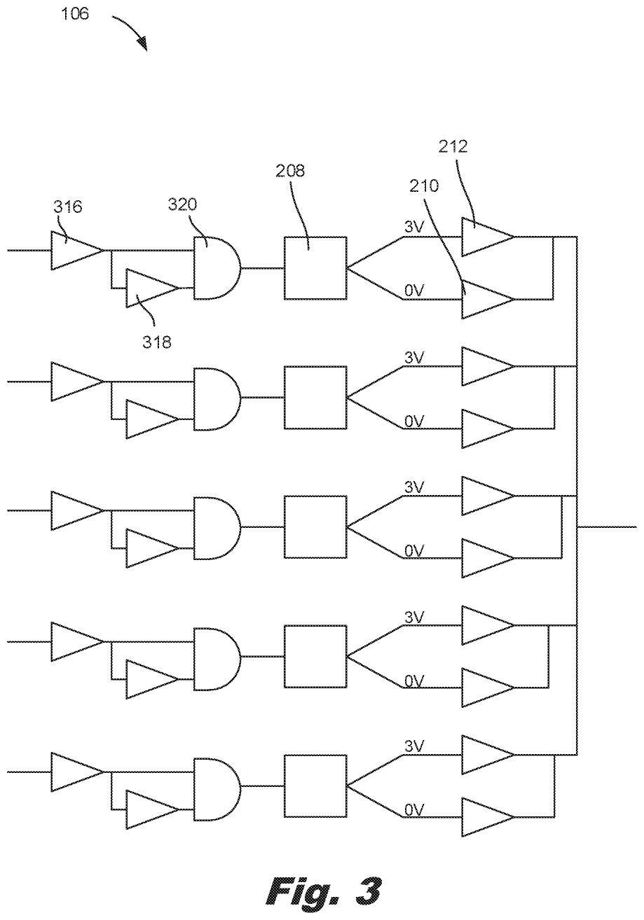

Note that while FIG. 2 depicts an example conversion circuit (106), other conversion circuits may be implemented in accordance with the principles described herein. That is, in other examples, the conversion circuit (106) may include different hardware components. While specific reference is made to a sequential polling control circuit (214), other methods may be executed to selectively enable certain pin (FIG. 1, 104) assignments such as that depicted in FIG. 3.

FIG. 3 is a circuit diagram of a conversion circuit (106) for assigning pin (FIG. 1, 104) outputs to voltage ranges. In this example, rather than sequentially enabling pairing of logic converters (210, 212), the conversion circuit (106) detects changes in the pin (FIG. 1, 104) outputs. When one output change is detected, that signal is passed on. Accordingly, the conversion circuit includes state detection circuitry. For simplicity, a single instance of the state detection circuitry components are indicated with reference numbers.

That is over time, a first pin (FIG. 1, 104-1) signal has an edge, meaning that the output signal changes from a low logic 0 V to a high logic 3 V or from a high logic 3 V to a low logic 0 V. In this example, upon a detection of a change for any pin (FIG. 1, 104), the conversion circuit (106) opens that pins (FIG. 1, 104-1) active path to the single wire, instead of waiting for the sequential rotation to come around.

In one particular example, the state detection circuitry includes a buffer (316) to let a signal pass through. Specifically, if the input from a pin is 3 V, the output of the buffer (316) is 3 V. Similar, if an input from a pin is 0 V, the output of the buffer (316) is 0 V. The signal then passes through a delayed inverter (318) which after a certain delay, for example 200 ms, converts the signal to its opposite level at the output of the delayed inverter (318). For example, if the input to the delayed inverter (318) is 3 V, then its output is 0 V. Accordingly, if an input to the delayed inverter (318) change from 3 V to 0 V, the output of the delayed inverter (318) changes from 0 V to 3 V after 200 ms. Both the output of the buffer (316) and the delayed inverter (318) are coupled to a logic AND gate (320) whose output is the logic AND between its two inputs. Accordingly, when both the output of the buffer (316) and the delayed inverter (318) are 3 V, the output of the logic AND gate (320) is 3 V. Otherwise, the output of the logic AND gate (320) is 0 V.

While FIG. 3 depicts one example of state detection circuitry, other examples of state detection circuitry may be implemented in accordance with the principles described herein.

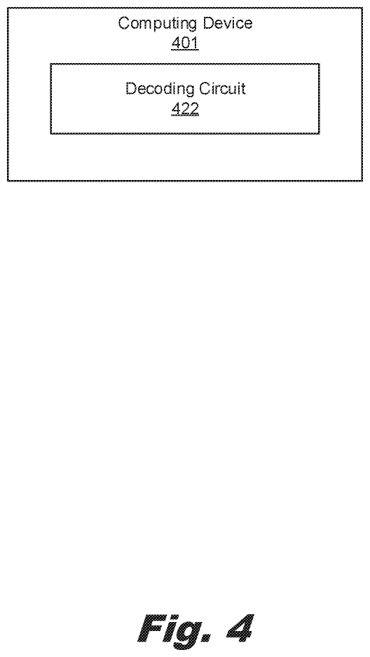

FIG. 4 is a block diagram of a computing device (401) for decoding signals based on voltage ranges. In some examples, a computing device may have both the conversion circuit (FIG. 1, 106) and the decoding circuit (422). That is, a computing device may include the conversion circuit (FIG. 1, 106) as described above to assign pin (FIG. 1, 104) outputs. The computing device may also include a decoding circuit (422) to decode and interpret input signals such that they may be routed to the appropriate pin on the computing device. In this example, the decoding circuit (422) may be on a different printed circuit board from the printed circuit board that houses the conversion circuit (FIG. 1, 106).

The decoding circuit (422) determines a source of a signal based on a voltage value of the signal. Specifically, the source of the signal may be a first pin when the voltage value is within a first voltage range and may be a second pin of an integrated circuit chip when the voltage value is within a second voltage range different from the first voltage range.

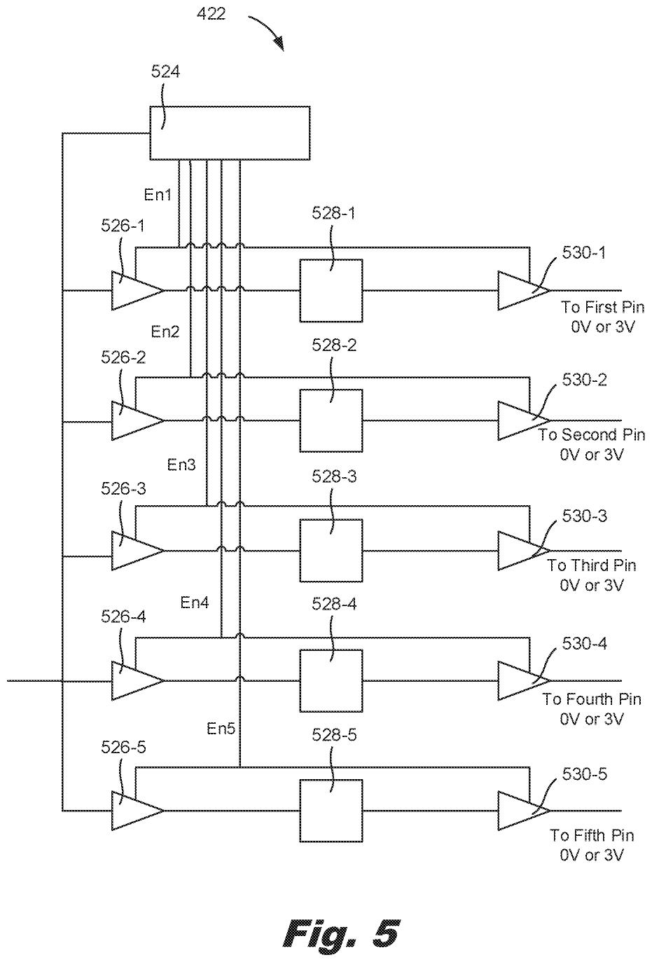

FIG. 5 is a circuit diagram of a decoding circuit (422) for decoding signals based on voltage ranges. In this example, the decoding circuit (422) includes a voltage band detector (524) and a decoder per output of the decoding circuit (422). A decoder includes an upstream operational amplifier (526), an offset adjustment device (528), and a downstream operational amplifier (530).

The voltage band detector (524) receives the input signal and performs an analog to digital conversion on a real-time input analog level. The voltage band detector (524) then enables the respective decoder. That is, as described above, signals may be assigned a voltage range and the decoding circuit (422) identifies a source of a signal and a logic state of that signal, based on a received voltage value. Table (3) below provides a mapping of input values to the decoding circuit (422) and pin assignments.

TABLE 3

| | Decoder (identified per | | |
|---|---|---|---|
| Input | upstream operational | Pin | |
| Voltage | amplifier (526)) | Assignment | Output Voltage |
| 0 V | 526-1 | 1 | 0 V (low logic) |
| 0.9 V | 526-1 | 1 | 3 V (high logic) |
| 1 V | 526-2 | 2 | 0 V (low logic) |
| 1.9 V | 526-2 | 2 | 3 V (high logic) |
| 2 V | 526-3 | 3 | 0 V (low logic) |
| 2.9 | 526-3 | 3 | 3 V (high logic) |
| 3 V | 526-4 | 4 | 0 V (low logic) |
| 3.9 V | 526-4 | 4 | 3 V (high logic) |
| 4 V | 526-5 | 5 | 0 V (low logic) |
| 4.9 V | 526-5 | 5 | 3 V (high logic) |

For example, based on the mapping in Table (3), if the voltage band detector (524) measures an input voltage of 2.9 V, then it activates the decoder associated with pin 3 while keeping the other decoders inactive.

Along an active path, the input voltage value is converted into a voltage value that corresponds to the logic high or logic low state of a respective pin. That is, the analog input value is converted to either a 0 V or 3 V output level. Continuing the example above, the 2.9 V signal would activate the third decoder and be converted to a 3 V value and passed to a corresponding pin (FIG. 1, 104).

Specifically, at an upstream operational amplifier (526), the signal is either allowed to pass or not, based on an enable signal received from the voltage band detector (524). The offset adjustment device (528) converts the analog signal into either a 0 V output, or a 3 V output. In this example, the offset adjustment device (528) of a first decoder has a different offset threshold as compared to an offset adjustment device (528) of a second decoder.

For example, relying on the mapping of Table (3) above, when the first decoder is enabled, due to the received signal being within 0-0.9 V, if a voltage output from the first upstream operational amplifier (526-1) of the first decoder is greater than 0.4 V, the first offset adjustment device (528-1) converts the signal to a 3 V value, otherwise the first offset adjustment device (528-1) converts the signal to a 0 V signal. In either case, the first downstream operational amplifier (530-1) of the first decoder, which is enabled by the same En1 enable signal, allows the signal to pass to the respective pin.

By comparison, when the second decoder is enabled, due to the received signal being within 1-1.9 V, if a voltage output from the second upstream operational amplifier (526-2) of the second decoder is greater than 1.4 V, the second offset adjustment device (528-2) converts the signal to a 3 V value, otherwise the second offset adjustment device (528-2) converts the signal to a 0 V signal. In either case, the second downstream operational amplifier (530-2) of the second decoder, which is enabled by the same En2 enable signal, allows the signal to pass to the respective pin.

By comparison, when the third decoder is enabled, due to the received signal being within 2-2.9 V, if a voltage output from the third upstream operational amplifier (526-3) of the third decoder is greater than 2.4 V, the third offset adjustment device (528-3) converts the signal to a 3 V value, otherwise the third offset adjustment device (528-3) converts the signal to a 0 V signal. In either case, the third downstream operational amplifier (530-3) of the third decoder, which is enabled by the same En3 enable signal, allows the signal to pass to the respective pin.

By comparison, when the fourth decoder is enabled, due to the received signal being within 3-3.9 V, if a voltage output from the fourth upstream operational amplifier (526-4) of the fourth decoder is greater than 3.4 V, the fourth offset adjustment device (528-4) converts the signal to a 3 V value, otherwise the fourth offset adjustment device (528-4) converts the signal to a 0 V signal. In either case, the fourth downstream operational amplifier (530-4) of the fourth decoder, which is enabled by the same En4 enable signal, allows the signal to pass to the respective pin.

By comparison, when the fifth decoder is enabled, due to the received signal being within 4-4.9 V, if a voltage output from the fifth upstream operational amplifier (526-5) of the fifth decoder is greater than 4.4 V, the fifth offset adjustment device (528-5) converts the signal to a 3 V value, otherwise the fifth offset adjustment device (528-5) converts the signal to a 0 V signal. In either case, the fifth downstream operational amplifier (530-5) of the fifth decoder, which is enabled by the same En5 enable signal, allows the signal to pass to the respective pin. While FIG. 5 depicts a particular configuration of the decoding circuit (422) other configurations may be implemented as well.

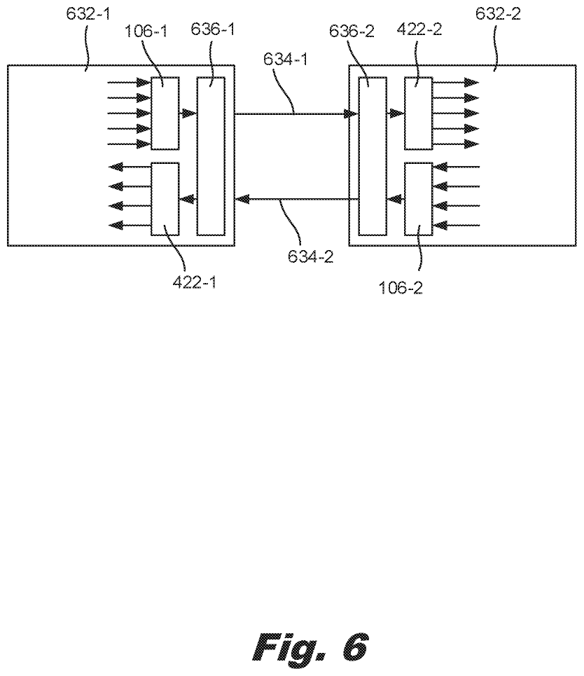

FIG. 6 is a diagram of two printed circuit boards (632-1, 632-2) with circuits for assigning and decoding pin signals based on voltage ranges. As a specific example, the first printed circuit board (632-1) may be a motherboard and the second printed circuit board (632-2) may be a daughterboard. Note that in this example, the printed circuit boards (632) include both a conversion circuit (106) and a decoding circuit (422).

Specifically, the first printed circuit board (632-1) includes a first conversion circuit (106-1) which converts signals to be transmitted to the second printed circuit board (632-2) and a decoding circuit (422-1) to decode signals received from the second printed circuit board (632-2). As a specific example, the first conversion circuit (106-1) may convert signals from 1) a USB power enable pin, 2) a power LED pin, 3) a Mute LED pin, 4) a USB power limit pin, and 5) a system reset pin to a second integrated circuit chip disposed on the second printed circuit board (632-2).

The second printed circuit board (632-2) includes a second conversion circuit (106-2) which converts signals to be transmitted to the first printed circuit board (632-1) and a decoding circuit (422-2) to decode signals transmitted from the first printed circuit board (632-1). As a specific example, the second conversion circuit (106-2) may convert signals from 1) a power button pin, 2) a mute button pin, 3) an audio volume up pin and 4) an audio volume down pin to the first integrated circuit chip disposed on the first printed circuit board (632-1).

As depicted in FIG. 6, the computing device (FIG. 1, 100) may also include a first wire (634-1) to transmit the voltage value from a conversion circuit (106-1) to a corresponding decoding circuit (422-2). That is, as described above, the first conversion circuit (106-1) may have multiple pins as inputs, but a single output along a wire which multiplexes the unique voltage values. Accordingly, the computing device (FIG. 1, 100) includes a connector (636-1) to couple the conversion circuit (106-1) to the first wire (634-1).

The computing device (FIG. 1, 100) may also include a second wire (634-2). That is, as described above, the first decoding circuit (422-1) may have multiple pins as outputs, but a single input along a wire which multiplexes the unique voltage values. Accordingly, the computing device (FIG. 1, 100) includes a connector (636-1) to couple the second wire (634-2) to the decoding circuit (422-1). As depicted in FIG. 6, in some examples a single connector (636-1) may be implemented. However, in some examples separate connectors may be used to couple the conversion circuit (106) and decoding circuit (422) to the respective wires (634).

The second printed circuit board (632-2) may include a second connector (636-2) that couples the conversion circuit (106-2) and the second decoding circuit (422-2) to the respective wires (634).

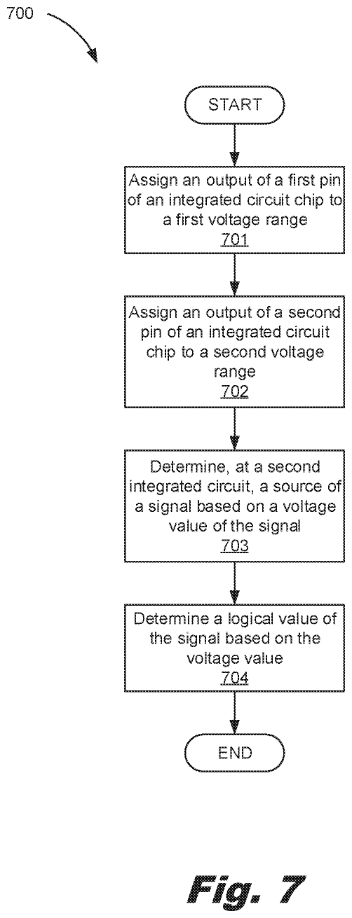

FIG. 7 is a flowchart of a method (700) for assigning and decoding pin signals based on voltage ranges.

According to the method (700), an output of a first pin (FIG. 1, 104-1) of a first integrated circuit chip is assigned (block 701) to a first voltage range. As a specific example, the conversion circuit (FIG. 1, 106) may include circuitry such as logic converters (FIG. 2, 210, 212) that convert an output received from a particular pin (FIG. 1, 104) to a voltage range uniquely assigned to that pin (FIG. 1, 104). One example of such a mapping is provided above in connection with Table (1).

The conversion circuit (FIG. 1, 106) may similarly assign (block 702) an output of a second pin (FIG. 1, 104-2) of a first integrated circuit chip to a second voltage range that is different from the first voltage range. That is, as is clearly depicted in Table (1), the output of a first pin (FIG. 1, 104-1) is assigned to the first voltage range which is between 0-0.9 V whereas an output of a second pin (FIG. 1, 104-2) is assigned to a second voltage range which is between 1 and 1.9 V.

More particularly, the conversion circuit (FIG. 1, 106) assigns unique voltage values within the respective voltage ranges to particular logical values. That is, as detailed above in Tables (2) and (3), logical values for a particular pin (FIG. 1, 104) are represented by a unique voltage value within its respective voltage range. It is this unique voltage value that is passed along the first wire (FIG. 6, 634-1) to a second integrated circuit chip.

At the second integrated circuit chip, a source of the signal is determined (block 703) based on a voltage value of the signal. The source is determined (block 703) to be the first pin (FIG. 1, 104-1) of the first integrated circuit chip when the voltage value is within the first voltage range. That is, in the specific example described above, when the received signal is within the range of 0-0.9 V, the source may be determined to be the first pin (FIG. 1, 104-1) of the first integrated circuit chip.

The source is determined (block 703) to be the second pin (FIG. 1, 104-2) of the first integrated circuit chip when the voltage value is within the second voltage range. That is, in the specific example described above, when the received signal is within the range of 1-1.9 V, the source may be determined to be the second pin (FIG. 1, 104-1) of the first integrated circuit chip.

The decoding circuit (FIG. 4, 442) can determine (block 704) a logical value of the signal based on the voltage value of the signal. That is, as described above, logical values of a pin are assigned a particular voltage value within its respective voltage range and the decoding circuit (FIG. 4, 442) can decode the logical values of the pin by detecting that the logical values within the range.

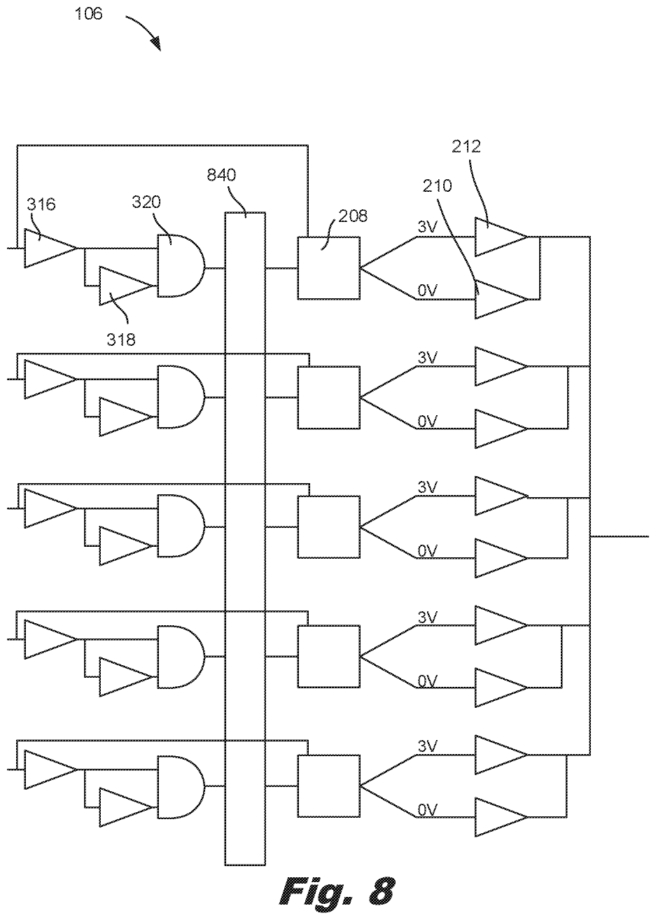

FIG. 8 is a circuit diagram of a conversion circuit (106) for assigning pin outputs to voltage ranges. In this example, the conversion circuit (106) includes a control circuit (840) such as an arbitor to select a voltage value to output along the wire (FIG. 6, 634).

That is, as described above, it may be the case that a detected change to a pin logical value may trigger activation of communication paths associated with that pin (FIG. 1, 104). In some examples, the state detection circuitry simultaneously detects a change in the output of the first pin (FIG. 1, 104-1) and a change in the output of the second pin (FIG. 1, 104-2). In this example, an order of transmission of the voltage value assigned to the output of the first pin (FIG. 1, 104-1) and the voltage value assigned to the output of the second pin (FIG. 1, 104-2) is prioritized to reduce voltage changes along a multiplexing transmission cable (FIG. 6, 634). For example, it may be the case that the state detection circuitry depicted in FIG. 3 detects a signal change on pin 1, pin 2, and pin 5 simultaneously. Were the order of transmission to be the first pin, fifth pin, and second pin, the voltage changes across the wire (FIG. 6, 634) would be to a voltage value between 0 V- 0.9 V, then to a voltage value between 4 V-4.9 V, and then to a voltage value between 1 V-1.9 V. Accordingly, this results in many and large voltage changes across the multiplexing transmission cable (FIG. 6, 634). Accordingly, the control circuit (840) may re-prioritize these voltages in increasing (or in other examples decreasing) order. For example, a first pin signal may be first transmitted, followed by the second pin, and followed by the fifth pin, such that the order of transmission is a voltage value between 0 V-0.9 V, then to a voltage value between 1 V-1.9 V, and then to a voltage value between 4 V-4.9 V. This reduces the overall changes to voltage values.

Accordingly, in this example, all inputs may be routed to the control circuit (840) which enables the associated converting circuits. In this example, the control circuit (840) is programmed with the output analog voltage levels and all the inputs. So, if multiple input edges are detected at the same time, the control circuit (840) can decide which converting circuit is prioritized and drives subsequent converting circuits with a delay.

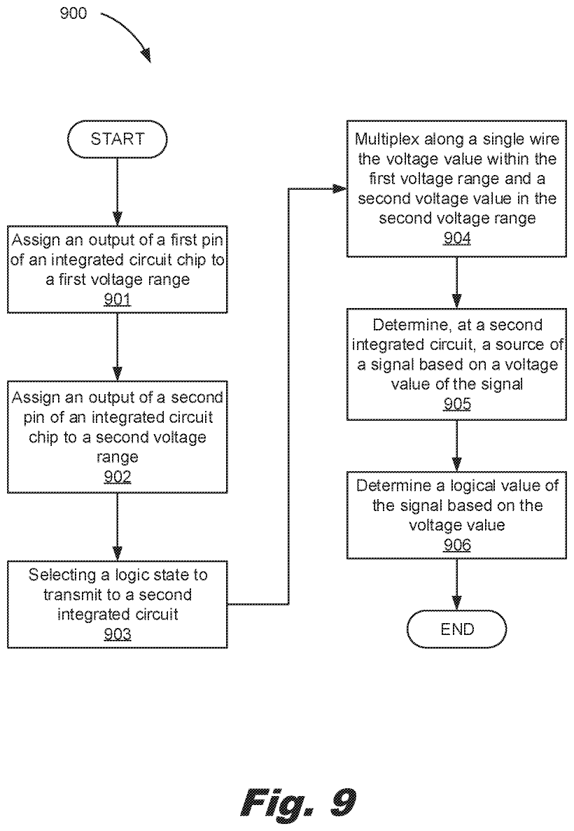

FIG. 9 is a flowchart of a method (900) for assigning and decoding pin signals based on voltage ranges. According to the method (900), an output of a first pin (FIG. 1, 104-1) is assigned (block 801) to a first voltage range and an output of a second pin (FIG. 1, 104-2) is assigned (block 802) to a second voltage range. This may be performed as described above in connection with FIG. 7.

In some examples, the method (900) includes selecting (block 903) a pin output to transmit to a second integrated circuit (FIG. 1, 102). In some examples, this may include sequentially polling the first pin (FIG. 1, 104-1) and the second pin (FIG. 1, 104-2) to determine a logical value of a respective output. That is, as described in FIG. 2, a control circuit (FIG. 2, 214) may sequentially pass through the enable signals giving a window by which it can transmit its logic value.

In another example, such as that depicted in FIG. 3, this selection (block 903) includes detecting a change in the output of the first pin (FIG. 1, 104-1 and the second pin (FIG. 1, 104-2).

In some examples, the conversion circuit (FIG. 1, 106) simultaneously detects a change in the output of the first pin (FIG. 1, 104-1) and a change in the output of the second pin (FIG. 1, 104-2). In this example, an order of transmission of the voltage value assigned to the output of the first pin (FIG. 1, 104-1) and the voltage value assigned to the output of the second pin (FIG. 1, 104-2) is prioritized to reduce voltage changes along a multiplexing transmission cable (FIG. 6, 634) as described above in connection with FIG. 8.

The computing device (FIG. 1, 100) then multiplexes (block 904) along a single wire from the first integrated circuit to the second integrated circuit, a voltage value within the first voltage range and a voltage value within the second voltage range. That is, as described above, a single wire is used to transmit multiple signals from multiple pins.

When this signal is received at a second integrated circuit chip, the second integrated circuit chip determines (block 905) a source of the signal based on the voltage value of the signal and determines (block 906) a logical value of the signal based on the voltage value. These operations may be performed as described above in connection with FIG. 7

What is claimed is:

1. A computing device, comprising:
an integrated circuit chip having a first pin and a second pin; and
a conversion circuit to:
assign an output of the first pin to a first voltage range;
assign the output of the first pin to a voltage value within the first voltage range based on a logical value of the output of the first pin;
assign an output of the second pin to a second voltage range that is different from the first voltage range; and
assign the output of the second pin to a voltage value within the second voltage range based on a logical value of the output of the second pin.

2. The computing device of claim 1, wherein the conversion circuit comprises, for the first pin:
a switch;
a first logic converter to assign the output of the first pin to a first voltage value within the first voltage range when the output of the first pin is a first logical value; and
a second logic converter to assign the output of the first pin to a second voltage value within the first voltage range when the output of the first pin is a second logical value.

3. The computing device of claim 2, wherein the first logic converter has a different offset value as compared to the second logic converter.

4. The computing device of claim 1, further comprising a wire to transmit the voltage value to another integrated circuit chip.

5. The computing device of claim 4, further comprising a connector to couple the conversion circuit to the wire.

6. The computing device of claim 4, further comprising a control circuit to select a voltage value to output along the wire.

7. A computing device, comprising:
a decoding circuit to:
determine a source of a signal based on a voltage value of the signal, wherein:
the source is a first pin of an integrated circuit chip when the voltage value is within a first voltage range; and
the source is a second pin of the integrated circuit chip when the voltage value is within a second voltage range different from the first voltage range; and
determine a logical value of the signal based on the voltage value.

8. The computing device of claim 7, wherein the decoding circuit comprises:
a voltage band detector; and
a decoder per output of the decoding circuit, the decoder comprising:
an upstream operational amplifier;
an offset adjustment device; and
a downstream operational amplifier.

9. The computing device of claim 8, wherein the offset adjustment device of a first decoder has a different offset threshold as compared to an offset adjustment device of a second decoder.

10. The computing device of claim 7, further comprising a wire to receive the signal from the integrated circuit chip.

11. A method, comprising:
assigning, with a conversion circuit, an output of a first pin of a first integrated circuit chip to a first voltage range;
assigning, with the conversion circuit, an output of a second pin of the first integrated circuit to a second voltage range that is different from the first voltage range;
determining, with a decoding circuit at a second integrated circuit chip, a source of a signal based on a voltage value of the signal, wherein:
the source is the first pin of the first integrated circuit chip when the voltage value is within the first voltage range; and
the source is the second pin of the first integrated circuit chip when the voltage value is within the second voltage range; and
determining a logical value of the signal based on the voltage value of the signal.

12. The method of claim 11, further comprising multiplexing along a single wire from the first integrated circuit to the second integrated circuit:
a voltage value within the first voltage range; and
a voltage value within the second voltage range.

13. The method of claim 11, further comprising sequentially polling the first pin and the second pin to determine a logical value to output.

14. The method of claim 11, further comprising detecting a change in the output of the first pin and the second pin to determine a logical value to output.

15. The method of claim 14, further comprising:
simultaneously detecting a change in the output of the first pin and a change in the output of the second pin; and
prioritizing an order of transmission of the voltage value assigned to the output of the first pin and the voltage value assigned to the output of the second pin to reduce voltage changes along a wire.
